(19) United States
(12) Patent Application Publication
(10) Pub. No.: US 2015/0095305 A1
(43) Pub. Date: Apr. 2, 2015

(54) DETECTING MULTISTEP OPERATIONS WHEN INTERACTING WITH WEB APPLICATIONS

(71) Applicant: International Business Machines Corporation, Armonk, NY (US)

(72) Inventor: Omer Tripp, Bronx, NY (US)

(73) Assignee: International Business Machines Corporation, Armonk, NY (US)

(21) Appl. No.: 14/041,002

(22) Filed: Sep. 30, 2013

(51) Int. Cl. G06F 17/30

(52) U.S. Cl. CPC G06F 17/30864
USPC 707/709; 707/758

(57) ABSTRACT

Detecting multistep operations when interacting with web applications is performed by identifying a set of multiple web pages of a web application, where the web pages in the set of multiple web pages are sequentially navigable, identifying a group of multiple web page elements at the same relative location in each of the web pages in the set of multiple web pages, determining that the identified groups of web page elements are similar to each other in accordance with a predefined similarity criterion, identifying an element that is common to each identified group of web page elements, and determining that a characteristic of the element is uniquely varied in each of the identified groups of web page elements.

### BACKGROUND

The present disclosure relates to testing computer software applications in general, and more particularly to detecting multistep operations when interacting with web applications.

So-called “web” applications typically include interrelated Hypertext Markup Language (HTML)-encoded web pages that are hosted by a computer server for access by one or more client computers via a computer network, such as the Internet. When testing web applications, dynamic analysis, or “black-box,” tools typically employ “crawling” techniques to navigate to the various web pages of a web application in order to expose its various interfaces for testing. Such techniques typically require a degree of interaction with the web pages as well. For example, consider an electronic commerce application where in order to place an order for a product a user must first provide a user name and password on a login web page, select a product for purchase on a product web page, provide shipping information on a shipping web page, provide credit card information on a payment web page, and perform a purchase confirmation operation on a confirmation web page. In order to test such multistep operations properly, a dynamic analysis tool would typically have to first provide valid credentials on the login page, and thereafter provide proper input to each of the subsequent web pages in the multistep operation and in the correct order.

The effectiveness of such dynamic analysis tools depends on their ability to uncover an application's interfaces, which in turn depends on their ability to navigate from one web page to another. Thus, in the previous example, if a dynamic analysis tool attempts to navigate to and interact with the purchase web page in the multistep operation without first properly navigating to and interacting with the earlier web pages in the multistep operation, an error state would likely be encountered, preventing the dynamic analysis tool from navigating to the confirmation web page and uncovering and testing its interfaces. This may result in a partial analysis, giving the tester the false impression that the application is safer and/or better than it really is.

### SUMMARY

In one embodiment of the present invention, a method is provided for detecting multistep operations when interacting with web applications by identifying a set of multiple web pages of a web application, where the web pages in the set of multiple web pages are sequentially navigable, identifying a group of multiple web page elements at the same relative location in each of the web pages in the set of multiple web pages, determining that the identified groups of web page elements are similar to each other in accordance with a predefined similarity criterion, identifying an element that is common to each identified group of web page elements, and determining that a characteristic of the element is uniquely varied in each of the identified groups of web page elements, thereby determining that the set of multiple web pages represents a multistep operation.

In other embodiments, systems and computer program products are provided.

### BRIEF DESCRIPTION OF THE SEVERAL VIEWS OF THE DRAWINGS

The embodiments of the present invention will be understood and appreciated more fully from the following detailed description taken in conjunction with the appended drawings in which:

FIG. 1 is a simplified conceptual illustration of a system for detecting multistep operations when interacting with web applications, constructed and operative in accordance with an embodiment of the invention;

FIG. 2 is a simplified flowchart illustration of an exemplary method of operation of the system of FIG. 1, operative in accordance with an embodiment of the invention;

FIG. 3 is a simplified source code example illustrating the system of FIG. 1 and method of FIG. 2;

FIG. 4 is a simplified web page image example illustrating the system of FIG. 1 and method of FIG. 2; and

FIG. 5 is a simplified block diagram illustration of an exemplary hardware implementation of a computing system, constructed and operative in accordance with an embodiment of the invention.

### DETAILED DESCRIPTION

The embodiments of the present invention will now be described, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java™, Smalltalk™, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

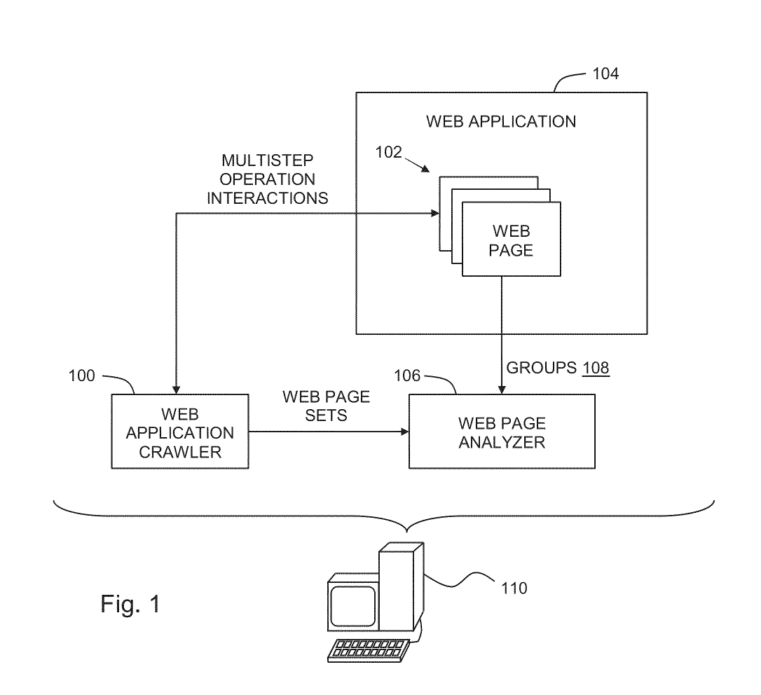

Reference is now made to FIG. 1 which is a simplified conceptual illustration of a system for detecting multistep operations when interacting with web applications, constructed and operative in accordance with an embodiment of the invention. In the system of FIG. 1, a web application crawler 100 is configured to access web pages 102 of a web application 104, such as where web application 104 includes multiple Hypertext Markup Language (HTML)-encoded web pages that are interrelated, such as where the web pages are interconnected via hyperlinks. In an embodiment, web application crawler 100 is configured to navigate to (i.e., retrieve) between web pages 102 using conventional crawling techniques. Web application crawler 100 is also configured to identify one or more sets of web pages 102 that are sequentially navigable. For example, the set of web pages {A, B, C, D, E} is sequentially navigable if web page A includes a hyperlink to web page B, web page B includes a hyperlink to web page C, web page C includes a hyperlink to web page D, and web page D includes a hyperlink to web page E. In another example, the set of web pages {A, B, C, D, E} is sequentially navigable if web page A includes executable software instructions, such as may be in the form of JavaScript™ code, that results in the navigation to web page B, such as by web application crawler 100, followed by the navigation to web page C, followed by the navigation to web page D, followed by the navigation to web page E.

A web page analyzer 106 is configured to identify a group 108 of multiple web page elements in each web page 102 of an identified set of sequentially navigable web pages 102, where the groups 108 are at the same relative location in each of the web pages 102. Web page analyzer 106 may, for example, determine that the groups 108 are at the same relative location by rendering each web page 102 and analyzing the rendered web pages in accordance with conventional techniques to determine the location of group 108 in the rendered web page. Alternatively, web page analyzer 106 may determine that the groups 108 are at the same relative location by determining that each group 108 has an identical XPath query from the root element of its web page 102.

Web page analyzer 106 is also configured to determine that the identified groups 108 of web page elements are similar to each other in accordance with a predefined similarity criterion. For example, web page analyzer 106 may generate a character histogram for each group 108 and determine that groups 108 are all similar if the cumulative differences between the character histograms are below a predefined threshold.

Web page analyzer 106 is also configured to identify an element that is common to each identified group 108 of web page elements, as well as determine that a characteristic of the element is uniquely varied in each of the identified groups 108. The identified element may, for example, be a text-based element, where a portion of the value of the text-based element is different in each of the groups 108. Alternatively, the identified element may be an image-based element, where a portion of the image is different in each of the groups 108.

Web page analyzer 106 is configured to determine that an identified set of sequentially navigable web pages 102 represents a multistep operation if: group of multiple web page elements is identified in each web page of the identified set; the identified groups of multiple web page elements are at the same relative location in each of the web pages of the identified set; the identified groups of multiple web page elements are similar to each other in accordance with a predefined similarity criterion; the identified groups of multiple web page elements include an element that is common to each of the group; a characteristic of the element is uniquely varied in each of the identified groups; and optionally if any, or all, of the following conditions are also met: if the number of web pages in the set of multiple web pages is not less than a predefined minimum number of web pages, such as not less than three web pages; if the number of web pages in the set of multiple web pages does not exceed a predefined maximum number of web pages, such as not more than ten web pages; if each of the identified groups of web page elements includes a predefined keyword associated with multistep operations, such as “step,” “progress,” or “next.”

In an embodiment, web page analyzer 106 is configured to operate as described hereinabove by performing static analysis of web pages 102 in accordance with conventional techniques.

Web application crawler 100 may be configured to interact, in accordance with conventional techniques, with a set of web pages that is identified as described hereinabove as representing a multistep operation, by sequentially navigating the web pages in accordance with the multistep operation, and in a manner that exposes the interfaces in each of the web pages of the multistep operation.

Any of the elements shown in FIG. 1 may be implemented by a computer, such by a computer 110, by implementing any of the elements in computer hardware and/or in computer software embodied in, e.g., a non-transitory, computer-readable storage medium in accordance with conventional techniques.

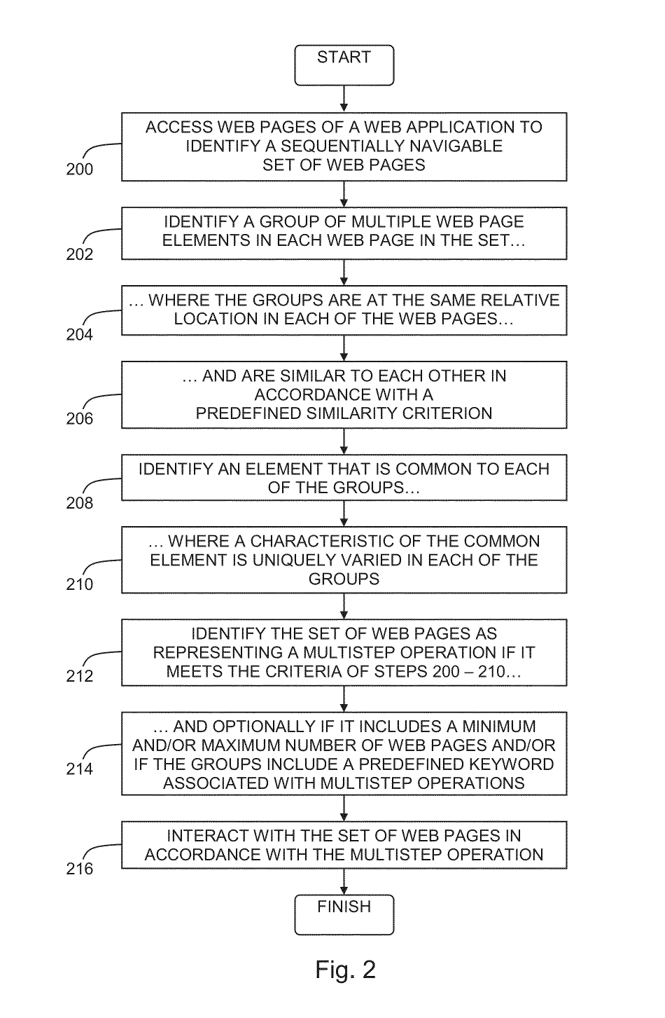

Reference is now made to FIG. 2, which is a simplified flowchart illustration of an exemplary method of operation of the system of FIG. 1, operative in accordance with an embodiment of the invention. In the method of FIG. 2, the web pages of a web application are accessed to identify a set of web pages that are sequentially navigable (step 200). A group of multiple web page elements is identified in each web page in the set (step 202) where the groups are at the same relative location in each of the web pages (step 204) and are similar to each other in accordance with a predefined similarity criterion (step 206). An element that is common to each of the groups is identified (step 208), where a characteristic of the common element is uniquely varied in each of the identified groups (step 210). The set of web pages is identified as representing a multistep operation if it meets the criteria of steps 200-210 (step 212), and optionally if it includes a minimum and/or maximum number of web pages and/or if the groups include a predefined keyword associated with multistep operations (step 214). The set of web pages that represents a multistep operation is interacted with, e.g., by sequentially navigating the web pages in accordance with the multistep operation, and in a manner that exposes the interfaces in each of the web pages of the multistep operation (step 216).

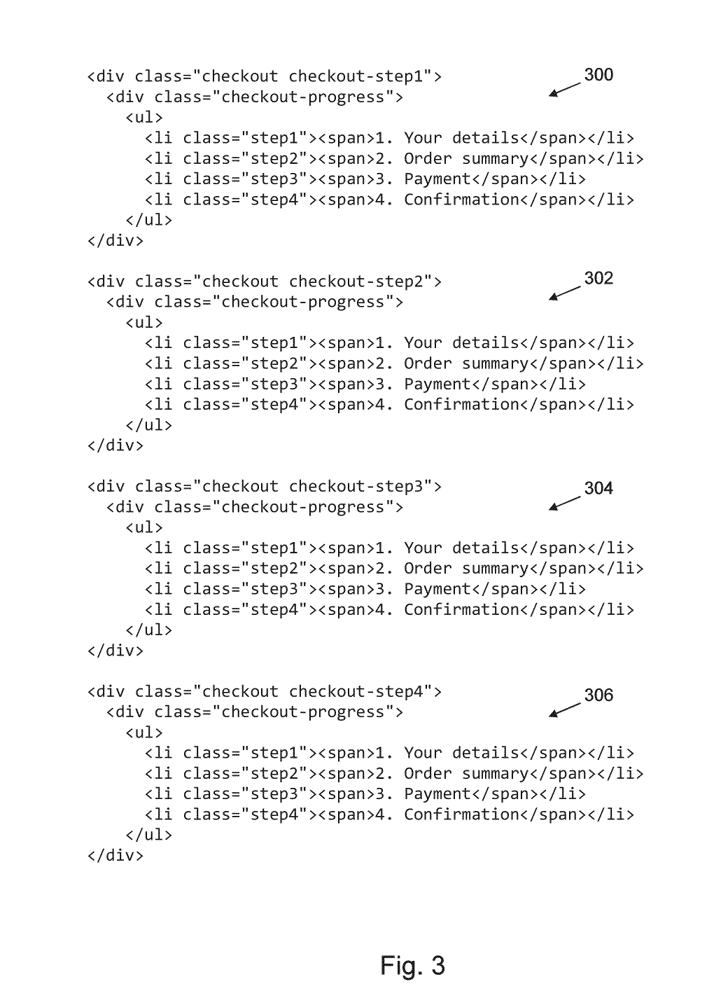

The system of FIG. 1 and method of FIG. 2 may be illustrated in the context of the example shown in FIG. 3 which shows groups 300-306 of multiple web page elements from four different web pages of a web application, where the web pages are members of a set of sequentially navigable web pages, and where groups 300-306 are at the same relative location in each of the web pages. The element <div class=“checkout checkout-stepn”> is common to groups 300 and 302, where “stepn” is uniquely varied in each of the identified groups, being “step1” in group 300, “step2” in group 302, “step3” in group 304, and “step4” in group 306. The set of web pages is identified as representing a multistep operation as it meets the criteria of FIG. 2, and may be interacted with in a manner that exposes the interfaces in each of the web pages in the set.

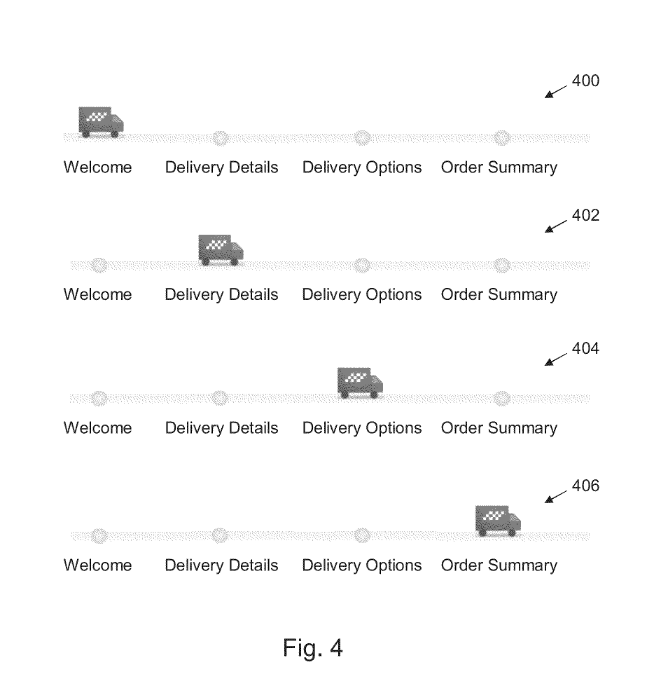

FIG. 4 shows four versions 400, 402, 404, and 406 of an image element that is common to similar groups of web page elements that are found at the same relative location in each of the web pages in a set of sequentially navigable web pages. As FIG. 4 shows, a portion of the image is different in each of the web pages, and the set of web pages is therefore identified as representing a multistep operation as it meets the criteria of FIG. 2.

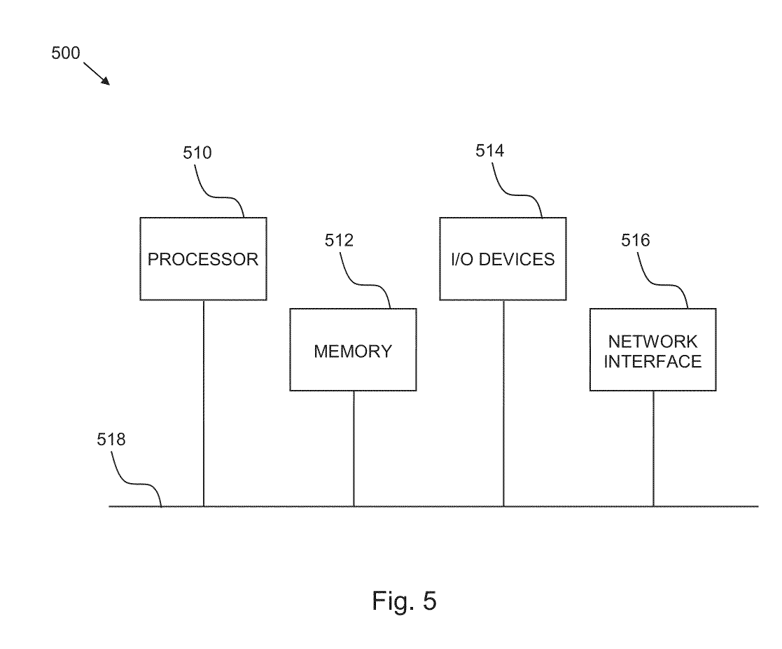

Referring now to FIG. 5, block diagram 500 illustrates an exemplary hardware implementation of a computing system in accordance with which one or more components/methodologies of the embodiments of the invention (e.g., components/methodologies described in the context of FIGS. 1-2) may be implemented, according to an embodiment of the invention.

As shown, the techniques for controlling access to at least one resource may be implemented in accordance with a processor 510, a memory 512, I/O devices 514, and a network interface 516, coupled via a computer bus 518 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The flowchart and block diagrams in the Figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that any of the elements described hereinabove may be implemented as a computer program product embodied in a computer-readable medium, such as in the form of computer program instructions stored on magnetic or optical storage media or embedded within computer hardware, and may be executed by or otherwise accessible to a computer.

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for detecting multistep operations when interacting with web applications, the method comprising:
identifying a set of multiple web pages of a web application, wherein the web pages in the set of multiple web pages are sequentially navigable;
identifying a group of multiple web page elements at the same relative location in each of the web pages in the set of multiple web pages;
determining that the identified groups of web page elements are similar to each other in accordance with a predefined similarity criterion;
identifying an element that is common to each identified group of web page elements; and
determining that a characteristic of the element is uniquely varied in each of the identified groups of web page elements,
thereby determining that the set of multiple web pages represents a multistep operation.

2. The method according to claim 1 wherein the identifying the set of multiple web pages comprises identifying a hyperlink path that enables sequential traversal of the web pages in the set of multiple web pages.

3. The method according to claim 1 wherein the identifying the group of multiple web page elements comprises determining that each of the groups of multiple web page elements has an identical XPath query from a root element of the web page in which the group of multiple web page elements is identified.

4. The method according to claim 1 wherein the determining that the identified groups of web page elements are similar comprises:
computing a character histogram of each of the groups of multiple web page elements; and
determining that cumulative differences between the histograms are below a redefined threshold.

5. The method according to claim 1
wherein the identifying an element that is common to each identified group of web page elements comprises identifying an image that is common to each identified group of web page elements, and
wherein the determining that a characteristic of the element is uniquely varied in each of the identified groups of web page elements comprises identifying that a different portion of the image is uniquely varied in each of the identified groups of web page elements.

6. The method according to claim 1 and further comprising performing the identifying and determining wherein the number of web pages in the set of multiple web pages is not less than a predefined minimum.

7. The method according to claim 1 and further comprising performing the identifying and determining wherein the number of web pages in the set of multiple web pages does not exceed a predefined maximum.

8. The method according to claim 1 and further comprising performing the identifying and determining wherein each of the identified groups of web page elements includes a predefined keyword associated with multistep operations.

9. The method according to claim 1 and further comprising sequentially interacting with the web pages in the set of multiple web pages in accordance with the multistep operation.

10. The method according to claim 1 wherein the identifying and determining are implemented in any of
computer hardware, and
computer software embodied in a non-transitory, computer-readable storage medium.

11. A system for detecting multistep operations when interacting with web applications, the system comprising:
a web application crawler configured to identify a set of multiple web pages of a web application, wherein the web pages in the set of multiple web pages are sequentially navigable; and
a web page analyzer configured to
identify a group of multiple web page elements at the same relative location in each of the web pages in the set of multiple web pages,
determine that the identified groups of web page elements are similar to each other in accordance with a predefined similarity criterion,
identify an element that is common to each identified group of web page elements, and
determine that a characteristic of the element is uniquely varied in each of the identified groups of web page elements.

12. The system according to claim 11 wherein a hyperlink path enables sequential traversal of the web pages in the set of multiple web pages.

13. The system according to claim 11 wherein each of the groups of multiple web page elements has an identical XPath query from a root element of the web page in which the group of multiple web page elements is identified.

14. The system according to claim 11 wherein cumulative differences between character histograms of the groups of multiple web page elements are below a predefined threshold.

15. The system according to claim 11 wherein the element that is common to each identified group of web page elements is an image that is common to each identified group of web page elements, and wherein the characteristic of the element that is uniquely varied in each of the identified groups of web page elements is that a different portion of the image is uniquely varied in each of the identified groups of web page elements.

16. The system according to claim 11 wherein the number of web pages in the set of multiple web pages is not less than a predefined minimum.

17. The system according to claim 11 wherein the number of web pages in the set of multiple web pages does not exceed a predefined maximum.

18. The system according to claim 11 wherein each of the identified groups of web page elements includes a predefined keyword associated with multistep operations.

19. The system according to claim 11 wherein the web application crawler and web page analyzer are implemented in any of
computer hardware, and
computer software embodied in a non-transitory, computer-readable storage medium.

20. A computer program product for detecting multistep operations when interacting with web applications, the computer program product comprising:
a computer-readable storage medium; and
computer-readable program code embodied in the computer-readable storage medium, wherein when executed by a computer the computer-readable program code is configured to
identify a set of multiple web pages of a web application, wherein the web pages in the set of multiple web pages are sequentially navigable,
identify a group of multiple web page elements at the same relative location in each of the web pages in the set of multiple web pages,
determine that the identified groups of web page elements are similar to each other in accordance with a predefined similarity criterion,
identify an element that is common to each identified group of web page elements, and
determine that a characteristic of the element is uniquely varied in each of the identified groups of web page elements.
